(19) United States
(12) Patent Application Publication
(10) Pub. No.: US 2024/0059012 A1
(43) Pub. Date: Feb. 22, 2024

(54) THREE-DIMENSIONAL-OBJECT PRINTING APPARATUS

(71) Applicant: SEIKO EPSON CORPORATION, Tokyo (JP)

(72) Inventor: Takanori SUZUKI, CHINO-SHI (JP)

(21) Appl. No.: 18/450,525

(22) Filed: Aug. 16, 2023

(30) Foreign Application Priority Data
Aug. 19, 2022 (JP) 2022-130883

(51) Int. Cl. B29C 64/241; B29C 64/209

(52) U.S. Cl. CPC B29C 64/241; B29C 64/209; B33Y 30/00

(57) ABSTRACT

A three-dimensional-object printing apparatus includes: a head unit including a head configured to eject liquid toward a workpiece and a drive substrate configured to generate a drive signal for driving the head; and a robot including a distal-end arm supporting the head unit and a distal-end joint located at the distal-end arm and enabling the head unit to rotate around a distal-end rotation axis, the robot being configured to change a position and an orientation of the head relative to the workpiece, and the distal-end rotation axis is located between the head and the drive substrate as viewed in an ejection direction in which the head ejects liquid.

The present application is based on, and claims priority from JP Application Serial Number 2022-130883, filed Aug. 19, 2022, the disclosure of which is hereby incorporated by reference herein in its entirety.

### BACKGROUND

### 1. Technical Field

The present disclosure relates to a three-dimensional-object printing apparatus.

### 2. Related Art

A three-dimensional-object printing apparatus that performs printing by an ink jet method on the surface of a three-dimensional workpiece is known. For example, JP-A-2017-19183 discloses a printing apparatus that performs printing while changing the position of the print head relative to the print target by using an articulated robot.

In general, the print head is electrically coupled to a drive substrate that generates drive signals for driving the print head. JP-A-2017-19183 does not refer to the drive substrate.

When the position of the drive substrate is fixed relative to the base portion of the articulated robot, the wiring for electrically coupling the print head and the drive substrate needs to be laid out along the arm of the articulated robot. In this case, the layout of the wiring is complicated. In addition, since the wiring is long, signals from the drive substrate can attenuate, and picked-up noise can affect the signals. Hence, it is conceivable to position the drive substrate at the distal end of the articulated robot together with the print head to shorten the wiring.

However, because the print head and the drive substrate are both heavy, providing both at the distal end of an articulated robot is likely to cause a problem of the load on the distal-end joint of the articulated robot increasing, and vibration of the distal-end joint does not converge quickly during a print operation, thereby degrading print quality.

### SUMMARY

A three-dimensional-object printing apparatus according to an aspect of the present disclosure includes: a head unit including a head configured to eject liquid toward a workpiece and a drive substrate configured to generate a drive signal for driving the head; and a robot including a distal-end arm supporting the head unit and a distal-end joint located at the distal-end arm and enabling the head unit to rotate around a distal-end rotation axis, the robot being configured to change a position and an orientation of the head relative to the workpiece, and the distal-end rotation axis is located between the head and the drive substrate as viewed in an ejection direction in which the head ejects liquid.

A three-dimensional-object printing apparatus according to another aspect of the present disclosure includes: a head unit including a head configured to eject liquid toward a workpiece and a drive substrate configured to generate a drive signal for driving the head; and a robot including a distal-end arm supporting the head unit and a distal-end joint located at the distal-end arm and enabling the head unit to rotate around a distal-end rotation axis, the robot being configured to change a position and an orientation of the head relative to the workpiece, and the distal-end rotation axis is located between a center of gravity of the head and a center of gravity of the drive substrate as viewed in an ejection direction in which the head ejects liquid.

### BRIEF DESCRIPTION OF THE DRAWINGS

FIG. 1 is a schematic diagram of a three-dimensional-object printing apparatus according to a first embodiment.

FIG. 2 is a block diagram of the electrical configuration of the three-dimensional-object printing apparatus according to the first embodiment.

FIG. 3 is a diagram for explaining a robot used in the first embodiment.

FIG. 4 is a perspective view of a head unit used in the first embodiment.

FIG. 5 is a cross-sectional view of a head chip illustrating a configuration example.

FIG. 6 is a flowchart illustrating an example of a print operation of the three-dimensional-object printing apparatus according to the first embodiment.

FIG. 7 is a diagram for explaining top-surface printing by the three-dimensional-object printing apparatus according to the first embodiment.

FIG. 8 is a diagram for explaining side-surface printing by the three-dimensional-object printing apparatus according to the first embodiment.

FIG. 9 is a schematic diagram of a three-dimensional-object printing apparatus according to a second embodiment.

FIG. 10 is a diagram for explaining the positional relationship between a head unit used in the second embodiment and a distal-end rotation axis.

FIG. 11 is a schematic diagram of a three-dimensional-object printing apparatus according to a modification example.

### DESCRIPTION OF EMBODIMENTS

Hereinafter, preferred embodiments according to the present disclosure will be described with reference to the attached drawings. The dimensions and reduced scale of each portion in the drawings differ from actual ones as appropriate, and some parts are schematically illustrated to facilitate understanding. The scope of the present disclosure is not limited to these embodiments unless specifically stated in the following description as limiting the present disclosure.

For convenience, the following description uses an X-axis, a Y-axis, and a Z-axis intersecting one another as necessary. One X-axis direction is the X1 direction, and the direction opposite to the X1 direction is the X2 direction. Similarly, the Y-axis directions opposite to each other are the Y1 direction and the Y2 direction. The Z-axis directions opposite to each other are the Z1 direction and the Z2 direction.

Here, the X-axis, the Y-axis, and the Z-axis correspond to the coordinate axes of the world coordinate system set in the space in which a robot 3 described later is installed. Typically, the Z-axis is the vertical axis, and the Z2 direction corresponds to the vertically downward direction. A base coordinate system based on a base portion of the robot 3 is set to be associated with the world coordinate system by calibration. For convenience, the following describes an example in which the operation of the robot 3 is controlled by using the world coordinate system as the robot coordinate system.

Note that the Z-axis is not limited to being the vertical axis. In addition, although the X-axis, the Y-axis, and the Z-axis are typically orthogonal to one another, the disclosure is not limited to these axes. There are also cases in which the axes are not orthogonal to one another. For example, the X-axis, the Y-axis, and the Z-axis have only to intersect one another at angles within the range of 80° to 100°, inclusive.

### 1. First Embodiment

### 1-1. Overall Configuration of Three-Dimensional-Object Printing Apparatus

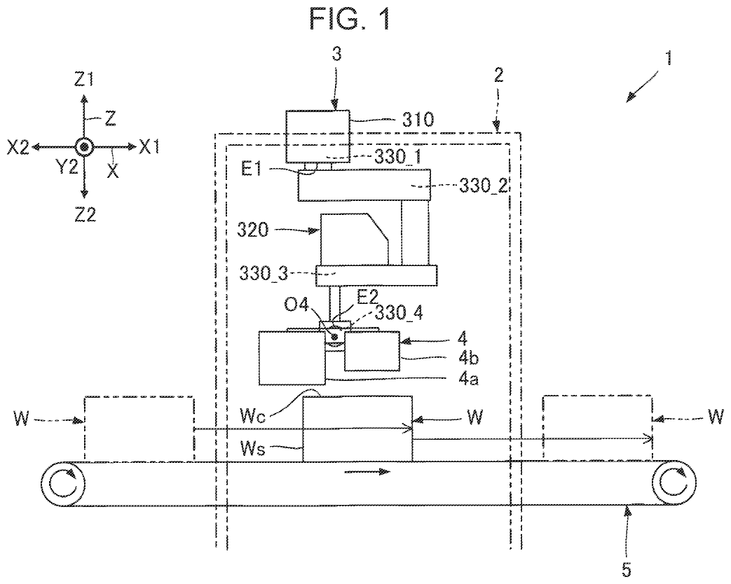

FIG. 1 is a schematic diagram of a three-dimensional-object printing apparatus 1 according to a first embodiment. The three-dimensional-object printing apparatus 1 is configured to perform printing by an ink jet method on a surface of a three-dimensional workpiece W by using the robot 3.

In the example illustrated in FIG. 1, the workpiece W is a rectangular parallelepiped. Here, the workpiece W has a top surface Wc facing the Z1 direction and four side surfaces Ws each facing a direction orthogonal to the Z-axis. The following describes an example in which top-surface printing that performs printing on the top surface Wc and side-surface printing that performs printing on one side surface Ws are performed sequentially. The workpiece W in the present embodiment is, for example, a box made of corrugated cardboard, and FIG. 1 illustrates an example in which a product produced in a factory or the like and packed in a corrugated cardboard box is being transported.

Note that the target surfaces of the workpiece W for printing are not limited to the surfaces described above. For example, only the top surface Wc or the side surface Ws may be the target surface, or two or more side surfaces Ws may be the target surfaces. In addition, the size, shape, placement position, and placement orientation of the workpiece W are not limited to the example illustrated in FIG. 1 and may be determined as appropriate.

As illustrated in FIG. 1, the three-dimensional-object printing apparatus 1 includes a frame 2, the robot 3, a head unit 4, and a transportation mechanism 5. First, the following describes each portion of the three-dimensional-object printing apparatus 1 illustrated in FIG. 1 simply and sequentially.

The frame 2 is a structure that supports the robot 3. In the example illustrated in FIG. 1, the frame 2 supports the robot 3 by suspending the robot 3 from the ceiling. Here, the frame 2 includes at least one beam extending horizontally and a plurality of pillars extending vertically and supporting the at least one beam. The frame 2 has an entrance for moving in the workpiece W being transported by the transportation mechanism 5 and an exit for moving out the workpiece W.

In FIG. 1, illustration of the frame 2 is simplified as indicated by dashed double-dotted lines in the figure. Note that the configuration of the frame 2 is not particularly limited and may be any configuration. The frame 2 is provided as necessary and may be omitted. In such a case, for example, the robot 3 may be supported by a ceiling of a building or the like.

The robot 3 is an articulated robot that changes the position and orientation of the head unit 4 in the world coordinate system. In the example illustrated in FIG. 1, the robot 3 is a 4-axis articulated robot including a base portion 310 and an arm portion 320, and in addition, a first joint 330_1, a second joint 330_2, a third joint 330_3, and a distal-end joint 330_4.

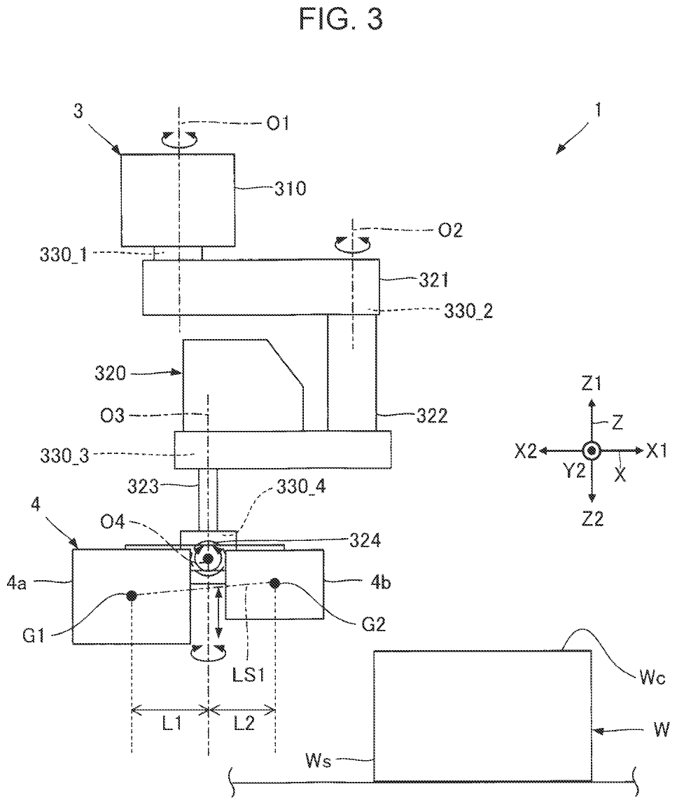

The base portion 310 is fixed to the frame 2 by screwing or the like. The proximal end E1 of the arm portion 320 is coupled to the base portion 310 via the first joint 330_1. The arm portion 320 includes the second joint 330_2, the third joint 330_3, and the distal-end joint 330_4. Each of the first joint 330_1, the second joint 330_2, and the third joint 330_3 is a rotary joint that rotates around an axis parallel to the Z-axis. Here, the third joint 330_3 also functions as a translational joint that extends and contracts along an axis parallel to the Z-axis. The distal-end joint 330_4 is the most distal of all the joints of the robot 3 and is a rotary joint that rotates around a distal-end rotation axis O4 which intersects the Z-axis. In the following, each of the first joint 330_1, the second joint 330_2, the third joint 330_3, and the distal-end joint 330_4 is referred to as “joint 330” in some cases. Details of the robot 3 will be described later with reference to FIG. 3.

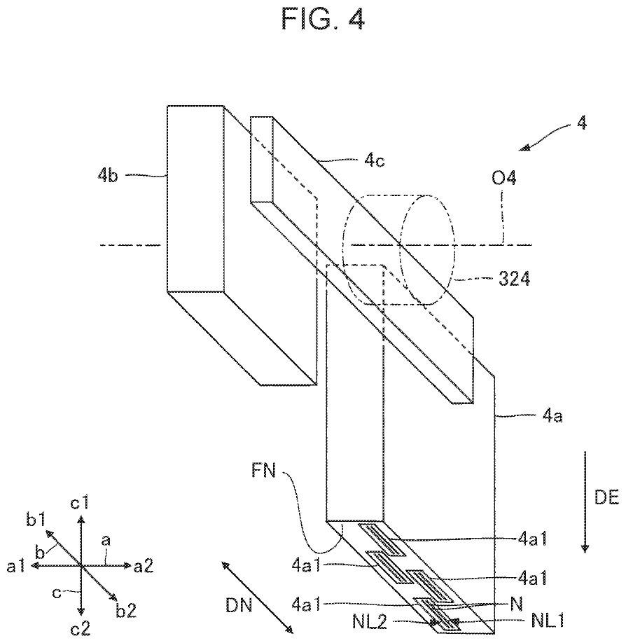

The head unit 4 is an assembly including a head 4a and a drive substrate 4b and is attached as an end effector to the distal end of the arm of the robot 3 by a fixing method such as screwing. Here, the distal-end rotation axis O4 is located between the head 4a and the drive substrate 4b. The head 4a ejects ink, which is an example of a liquid, toward the workpiece W. The drive substrate 4b generates a drive signal for driving the head 4a. Details of the head unit 4 will be described later with reference to FIG. 4.

The type of the ink is not particularly limited, and examples of the ink include a water-based ink in which a coloring material such as a dye or a pigment is dissolved in a water-based solvent, a curable ink containing a curable resin such as an ultraviolet curable resin, and a solvent-based ink in which a coloring material such as a dye or a pigment is dissolved in an organic solvent. The type of curable ink is not particularly limited, and for example, the curable ink may be any one of a thermosetting type, a photo-curing type, a radiation-curing type, and an electro-beam-curing type. The ink is not limited to a solution and may be an ink in which a coloring material or the like is dispersed as a dispersoid in a dispersion medium. The ink is not limited to an ink containing a coloring material and may also be, for example, an ink containing, as a dispersoid, conductive particles such as metal particles to form wiring or the like; a clear ink; or a treatment liquid for treating the surface of the workpiece W. In addition, ink of a plurality of types may be used.

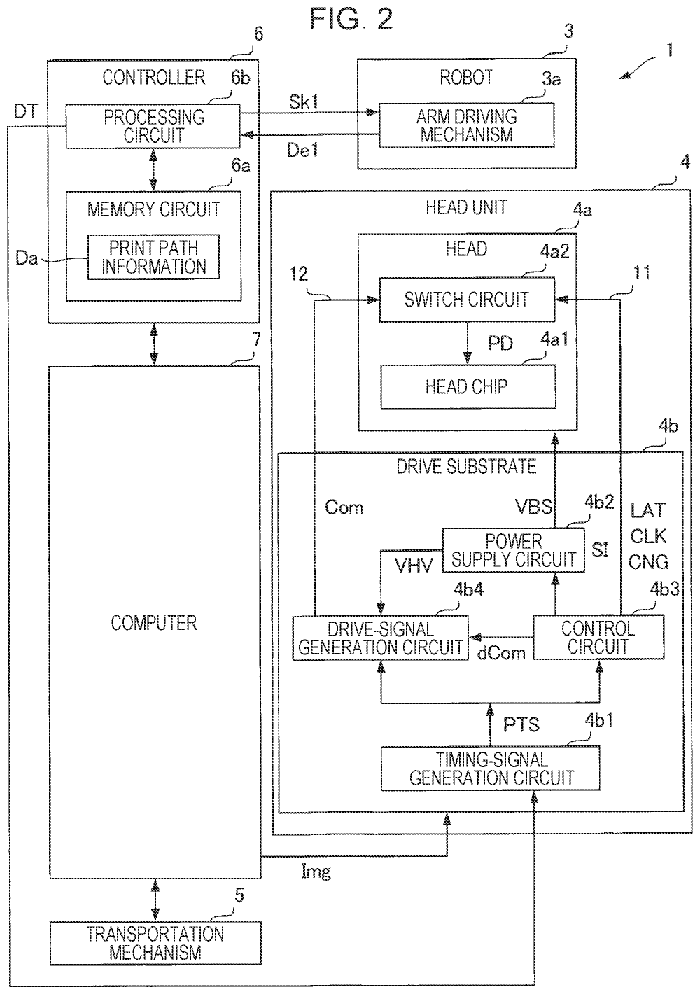

The transportation mechanism 5 is configured to change the position of the workpiece W in the world coordinate system. In the example illustrated in FIG. 1, the transportation mechanism 5 is a belt conveyor that moves the workpiece W in the X1 direction. In the present embodiment, the transportation mechanism 5 moves the workpiece W into and out of the print area of the robot 3 under control of a computer 7, described later, illustrated in FIG. 2. The transportation mechanism 5 has a sensor (not illustrated) for detecting the position in the X-axis direction of the workpiece W on the transportation mechanism 5, and driving of the transportation mechanism 5 is controlled in accordance with the detection results of the sensor. The sensor is, for example, an optical position sensor. In FIG. 1, the workpiece W before being moved into the print area and after being moved out of the print area is indicated by dashed double-dotted lines.

Note that the way of detecting the position in the X-axis direction of the workpiece W on the transportation mechanism 5 is not limited to detection by an optical position sensor and may be, for example, based on the output of an encoder for detecting the amount of operation of the transportation mechanism 5. In addition, the transportation mechanism 5 is not limited to a belt conveyor and may be, for example, a conveyor of another type, such as a roller conveyor, or may be an articulated robot, a self-propelled trolley, a slider mechanism with a linear motor, or the like. When the workpiece W is a corrugated cardboard box, if a roller conveyor is used for the transportation mechanism 5, the bottom surface of the corrugated cardboard box may come into contact with and be rubbed by rollers of the roller conveyor, which can produce paper dust. If the paper dust attaches to a nozzle surface FN described later of the head 4a, it can cause an ink ejection failure. Hence, the transportation mechanism 5 should preferably be a mechanism that is not likely to rub the bottom surface of a corrugated cardboard box.

Since the distal-end rotation axis O4 is located between the head 4a and the drive substrate 4b in the three-dimensional-object printing apparatus 1 having the overall configuration as above, the load on the distal-end joint 330_4 of the robot 3 is low, which improves the reliability of the robot 3 and reduces vibration of the head unit 4 during a print operation, leading to an improvement in print quality.

### 1-2. Electrical Configuration of Three-Dimensional-Object Printing Apparatus

FIG. 2 is a block diagram of the electrical configuration of the three-dimensional-object printing apparatus 1 according to the first embodiment. FIG. 2 illustrates electrical components of the components of the three-dimensional-object printing apparatus 1. As illustrated in FIG. 2, the three-dimensional-object printing apparatus 1 includes, in addition to the components illustrated in the FIG. 1 described above, a controller 6 and the computer 7.

Each of the electrical components illustrated in FIG. 2 may be divided as appropriate. Part of a component may be included in another, and a component may be integrated with another. For example, some or all of the functions of the controller 6 may be implemented by the computer 7 or may be implemented by another external device such as a personal computer (PC) coupled to the controller 6 via a network such as a local area network (LAN) or the Internet.

The controller 6 has a function of controlling driving of the robot 3 and a function of generating a signal DT for synchronizing the ink ejection operation of the head unit 4 with the operation of the robot 3.

The controller 6 includes a memory circuit 6a and a processing circuit 6b.

The memory circuit 6a stores various programs executed by the processing circuit 6b and various kinds of data processed by the processing circuit 6b. Note that part of or the whole of the memory circuit 6a may be included in the processing circuit 6b.

The memory circuit 6a stores print path information Da. The print path information Da is used to control the operation of the robot 3 and includes information on the position and orientation of the head 4a on the path that the head 4a is to move along. The print path information Da is expressed, for example, by using coordinate values in the base coordinate system or the world coordinate system. The print path information Da is generated by the computer 7, for example, in accordance with three dimensional data expressing the shape of the workpiece W. The print path information Da is input from the computer 7 into the memory circuit 6a. Note that the print path information Da may be expressed by using coordinate values in a workpiece coordinate system. In such a case, the print path information Da is converted from the coordinate values in the workpiece coordinate system into coordinate values in the base coordinate system or the world coordinate system, and the converted print path information Da is then used to control the operation of the robot 3.

The processing circuit 6b controls the operation of an arm driving mechanism 3a of the robot 3 in accordance with the print path information Da and also generates the signal DT.

Here, the arm driving mechanism 3a is the aggregate of the driving mechanisms for the first joint 330_1 to the distal-end joint 330_4 described above and includes, for each joint 330, a motor for driving the joint 330 of the robot 3 and an encoder for detecting the rotation angle of the joint 330 of the robot 3.

The processing circuit 6b performs an inverse kinematics calculation which is an operation of converting the print path information Da into the amount of operation of each joint 330 of the robot 3, such as the rotation angle, the rotation speed, and the like. Then, the processing circuit 6b outputs a control signal Sk1 in accordance with the output De1 of each encoder of the arm driving mechanism 3a such that the amount of actual operation of each joint 330, such as the actual rotation angle and the rotation speed, is equal to the above calculation results based on the print path information Da. The control signal Sk1 is for controlling driving of the motors of the arm driving mechanism 3a. Here, the control signal Sk1 is corrected as necessary by the processing circuit 6b in accordance with output from a distance sensor (not illustrated).

The processing circuit 6b generates the signal DT in accordance with the output De1 from at least one of the plurality of encoders of the arm driving mechanism 3a. For example, the processing circuit 6b generates a trigger signal, as the signal DT, including a pulse at the timing when the output De1 from one of the encoders becomes a specified value.

The drive substrate 4b of the head unit 4 is a circuit that controls the ink ejection operation of the head 4a in accordance with the signal DT output from the controller 6 and print data Img from the computer 7. The drive substrate 4b includes a timing-signal generation circuit 4b1, a power supply circuit 4b2, a control circuit 4b3, and a drive-signal generation circuit 4b4.

The timing-signal generation circuit 4b1 generates a timing signal PTS in accordance with the signal DT. The timing-signal generation circuit 4b1 includes, for example, a timer that is triggered at the detection of the signal DT to start generating the timing signal PTS.

The power supply circuit 4b2 is supplied with electric power from a commercially available power supply (not illustrated) and generates various specified electric potentials. The various generated potentials are supplied as appropriate to several portions of the head 4a and the drive substrate 4b. For example, the power supply circuit 4b2 generates a power supply potential VHV and an offset potential VBS. The offset potential VBS is supplied to the head 4a. The power supply potential VHV is supplied to the drive-signal generation circuit 4b4.

The control circuit 4b3 generates a control signal SI, a waveform specifying signal dCom, a latch signal LAT, a clock signal CLK, and a change signal CNG in accordance with the timing signal PTS. These signals are synchronized with the timing signal PTS. Of these signals, the waveform specifying signal dCom is input to the drive-signal generation circuit 4b4 and a switch circuit 4a2 of the head unit 4 via wiring 12, and the other signals are input to the switch circuit 4a2 of the head unit 4 via wiring 11.

The control signal SI is a digital signal for specifying the operational states of drive elements Ea and Eb, described later, included in head chips 4a1 of the head 4a. Specifically, the control signal SI is for specifying whether to supply a drive signal Com described later to the drive elements Ea and Eb, in accordance with the print data Img. This specification determines, for example, whether to eject ink from the nozzle associated with each of the drive elements Ea and Eb and the amount of ink to be ejected from the nozzle. The waveform specifying signal dCom is a digital signal for defining the waveform of the drive signal Com. The latch signal LAT and the change signal CNG, which are used in parallel with the control signal SI, define the drive timings of the drive elements Ea and Eb and in turn define the ejection timings of ink from the nozzles. The clock signal CLK serves as a reference synchronized with the timing signal PTS.

The control circuit 4b3 described above includes, for example, one or more processors, such as a CPU. Note that the control circuit 4b3 may include, instead of or in addition to a CPU, a programmable logic device, such as an FPGA.

The drive-signal generation circuit 4b4 is configured to generate the drive signal Com for driving the drive elements Ea and Eb included in the head chips 4a1 of the head 4a. Specifically, the drive-signal generation circuit 4b4 includes, for example, a DA conversion circuit and an amplifier circuit. In the drive-signal generation circuit 4b4, the DA conversion circuit converts the waveform specifying signal dCom from the control circuit 4b3, which is a digital signal, into an analog signal. The amplifier circuit amplifies the analog signal by using the power supply potential VHV from the power supply circuit 4b2 to generate the drive signal Com. Here, the drive signal Com is a pulse signal including pulse waveforms. Of the waveforms included in the drive signal Com, the signal of the waveform to be actually supplied to the drive elements Ea and Eb is a drive pulse PD. The drive pulse PD is supplied from the drive-signal generation circuit 4b4 to the drive elements Ea and Eb via the switch circuit 4a2 of the head 4a.

Here, the switch circuit 4a2 includes a switching element configured to switch, in accordance with the control signal SI, between whether to supply at least part of the waveforms included in the drive signal Com as drive pulses PD or not.

The computer 7 is, for example, a desktop computer, a laptop computer, or the like having a specified program installed. The computer 7 has a function of generating the print data Img and the print path information Da, a function of supplying the controller 6 with information such as the print path information Da, and a function of supplying the drive substrate 4b with information such as the print data Img. The computer 7 of the present embodiment has, in addition to these functions, a function of controlling driving of the transportation mechanism 5.

### 1-3. Robot

FIG. 3 is a diagram for explaining the robot 3 used in the first embodiment. As illustrated in FIG. 3, the robot 3 includes the base portion 310 and the arm portion 320.

The base portion 310 is a holder that supports the arm portion 320 and is fixed to the frame 2 illustrated in FIG. 2 described above by screwing or the like.

The arm portion 320 is a 4-axis robot arm including the proximal end E1 attached to the base portion 310 and a distal end E2 whose three-dimensional position and orientation change relative to the proximal end E1. Specifically, the arm portion 320 includes a first arm 321, a second arm 322, a third arm 323, and a distal-end arm 324, which are coupled to one another in this order.

The first arm 321 is coupled to the base portion 310 via the first joint 330_1 so as to be configured to rotate around a first axis O1 relative to the base portion 310. In the example illustrated in FIG. 3, the first axis O1 is the axis parallel to the Z-axis. The first arm 321 has a shape extending from the Z2 direction end of the base portion 310 in a direction orthogonal to the Z-axis. The first joint 330_1 has a driving mechanism that rotates the first arm 321 relative to the base portion 310. This driving mechanism is part of the arm driving mechanism 3a described above and includes, for example, a motor that generates a driving force for the rotation, a speed reducer that reduces the speed resulting from the driving force and outputs the resultant, and an encoder, such as a rotary encoder, that detects the amount of operation such as the rotation angle.

The second arm 322 is coupled to the first arm 321 via the second joint 330_2 so as to be configured to rotate around a second axis O2 relative to the first arm 321. In the example illustrated in FIG. 3, the second axis O2 is the axis parallel to the Z-axis. The second arm 322 has a shape extending in the Z2 direction from the distal end portion in the longitudinal direction of the first arm 321 and then extending in a direction orthogonal to the Z-axis. The second joint 330_2 has a driving mechanism that rotates the second arm 322 relative to the first arm 321. This driving mechanism is part of the arm driving mechanism 3a described above and includes, for example, a motor that generates a driving force for the rotation, a speed reducer that reduces the speed resulting from the driving force and outputs the resultant, and an encoder, such as a rotary encoder, that detects the amount of operation such as the rotation angle.

The third arm 323 is coupled to the second arm 322 via the third joint 330_3 configured to rotate around a third axis O3 and also configured to extend and contract along the third axis O3 relative to the second arm 322. In the example illustrated in FIG. 3, the third axis O3 is the axis parallel to the Z-axis. The third arm 323 is a columnar operating shaft protruding from a distal end portion of the second arm 322 and extending in the Z-axis direction. The third joint 330_3 has a driving mechanism that rotates the third arm 323 around the center axis and moves the third arm 323 up and down along the center axis, which enables the third arm 323 to rotate around and extend and contract along the third axis O3. This driving mechanism is part of the arm driving mechanism 3a described above and includes, for example, a rotation mechanism such as a ball screw mechanism for the rotation, an elevation mechanism such as a ball spline mechanism for the upward and downward movement, a motor that generates a driving force for the rotation and the upward and downward movement, and an encoder that detects the amount of operation of the rotation and the upward and downward movement.

The distal-end arm 324 is coupled to the third arm 323 via the distal-end joint 330_4 so as to be configured to rotate around the distal-end rotation axis O4 relative to the third arm 323. In the example illustrated in FIG. 3, the distal-end rotation axis O4 is the axis orthogonal to the Z-axis. The distal-end arm 324 is attached to a Z2-direction end portion of the third arm 323. The distal-end joint 330_4 has a driving mechanism that rotates the distal-end arm 324 relative to the third arm 323. This driving mechanism is part of the arm driving mechanism 3a described above and may include, for example, a motor that generates a driving force for the rotation, a speed reducer that reduces the speed resulting from the driving force and outputs the resultant, and an encoder, such as a rotary encoder, that detects the amount of operation such as the rotation angle. Note that as another example, the driving mechanism may include a rotary cylinder or the like that is rotated by compressed air.

In the robot 3 described above, the first axis O1, the second axis O2, and the third axis O3 are parallel to one another, and the distal-end rotation axis O4 is orthogonal to the third axis O3. Regarding these rotation axes, the meaning of “orthogonal” includes not only the case in which the angle between two rotation axes is strictly 90° but also cases in which the angle between two rotation axes has a deviation within a range of ±5° or so relative to 90°. Similarly, the meaning of “parallel” includes not only the case in which two rotation axes are strictly parallel but also cases in which one of two rotation axes is inclined relative to the other by an angle within a range of ±5° or so.

The robot 3 configured as above is built, for example, by using an off-the-shelf SCARA robot. Specifically, for example, the robot 3 can be built by adding the distal-end joint 330_4 and the distal-end arm 324 to the distal end of an off-the-shelf 4-axis SCARA robot. In this way, the robot 3 may have a configuration in which an end effector having a joint function is added to an off-the-shelf robot, and the end effector is one of the components of the robot 3. Hence, when the robot 3 includes a robot and an end effector, the most distal joint of the plurality of rotary joints in the configuration including the robot and the end effector corresponds to the distal-end joint 330_4, and the rotation axis of the distal-end joint 330_4 corresponds to the distal-end rotation axis O4. Note that the robot 3 may be built without using an off-the-shelf robot.

The head unit 4 is attached as an end effector to the distal-end arm 324 of the robot 3 described above by being fixed by screwing or the like. Here, the head unit 4 is configured such that the moment of the head unit 4 around the distal-end rotation axis O4 is smaller.

Specifically, the distal-end rotation axis O4 is located between the center of gravity G1 of the head 4a and the center of gravity G2 of the drive substrate 4b as viewed in the ejection direction in which the head 4a ejects ink. In the example illustrated in FIG. 3, the distal-end rotation axis O4 is located between the head 4a and the drive substrate 4b as viewed in the ejection direction in which the head 4a ejects ink. Also, as viewed in the direction parallel to the distal-end rotation axis O4, the distal-end rotation axis O4 is located between the head 4a and the drive substrate 4b.

Here, to reduce the moment of the head unit 4 around the distal-end rotation axis O4, the distal-end rotation axis O4 should preferably be close to the line segment LS1 connecting the center of gravity G1 and the center of gravity G2 as viewed in the direction parallel to the distal-end rotation axis O4. From the same or a similar viewpoint, it is preferable that the distance L1 between the distal-end rotation axis O4 and the center of gravity G1 and the distance L2 between the distal-end rotation axis O4 and the center of gravity G2 be as small as possible.

The relationship between the magnitudes of the distances L1 and L2 should preferably be determined in accordance with the relationship between the magnitudes of the masses of the head 4a and the drive substrate 4b. Specifically, when the mass of the head 4a is larger than the mass of the drive substrate 4b, the distance L1 is shorter than the distance L2. In contrast, when the mass of the head 4a is smaller than the mass of the drive substrate 4b, it is preferable that the distance L1 be longer than the distance L2.

### 1-4. Head Unit

FIG. 4 is a perspective view of the head unit 4 used in the first embodiment. For convenience, the following description uses an a-axis, a b-axis, and a c-axis intersecting one another as necessary. In the following description, one a-axis direction is the a1 direction, and the direction opposite to the a1 direction is the a2 direction. Similarly, the b-axis directions opposite to each other are the b1 direction and the b2 direction. The c-axis directions opposite to each other are the c1 direction and the c2 direction.

Here, the a-axis, the b-axis, and the c-axis correspond to the coordinate axes of a tool coordinate system set for the head unit 4, and the relationship of the position and orientation relative to the world coordinate system or the robot coordinate system described above changes in accordance with the operation of the robot 3 described above. In the example illustrated in FIG. 4, the a-axis is parallel to the distal-end rotation axis O4 described above. Although the a-axis, the b-axis, and the c-axis are typically orthogonal to one another, the disclosure is not limited to these axes. For example, the axes have only to intersect one another at angles within the range of 80° to 100°, inclusive. The tool coordinate system and the base coordinate system or the robot coordinate system are set to be associated with each other by calibration.

The tool coordinate system is set with respect to the tool center point. Hence, the position and orientation of the head 4a is defined with respect to the tool center point. For example, the tool center point may be set to be at the center of the nozzle surface FN described later, or may be set to be in a space a certain distance away from the head 4a in the ink ejection direction DE.

The head unit 4 includes, in addition to the head 4a and the drive substrate 4b described above, a support 4c that supports the head 4a and the drive substrate 4b. Note that the head unit 4 may include components other than the head 4a, the drive substrate 4b, and the support 4c. For example, when a UV curable ink is used, the head unit 4 may include a light source for curing the ink.

The support 4c is made of, for example, a metal material or the like and is a substantially rigid body. In FIG. 4, the support 4c has an elongated plate shape extending in the b-axis direction and having the thickness in the a-axis direction; however, the shape of the support 4c is not particularly limited and may be any shape. The support 4c may be provided as necessary and may be omitted. When the support 4c is omitted, for example, the head 4a and the drive substrate 4b may be directly fixed to the distal-end arm 324 by screwing or the like.

The support 4c described above is attached to the distal-end arm 324. Hence, the head 4a and the drive substrate 4b are supported together by the distal-end arm 324 due to the presence of the support 4c. Thus, the positions of the head 4a and the drive substrate 4b relative to the distal-end arm 324 are fixed. In the example illustrated in FIG. 4, the head 4a and the drive substrate 4b are aligned in the b-axis direction. With respect to the position of the distal-end rotation axis O4, the head 4a is located in the b2 direction, and the drive substrate 4b is located in the b1 direction.

The head 4a has the nozzle surface FN. The nozzle surface FN includes nozzle plates 18c described later, each having a plurality of nozzles N as through holes, and the surfaces of members located substantially on the same plane as the surfaces of the nozzle plates 18c. In the example illustrated in FIG. 4, the direction normal to the nozzle surface FN, in other words, the ejection direction DE in which the nozzles N eject ink, is the c2 direction.

In the example illustrated in FIG. 4, the head 4a has four head chips 4a1. The four head chips 4a1 are composed of two head chips 4a1 aligned in the b-axis direction and two head chips 4a1 aligned in the b-axis direction and spaced apart from the aforementioned two head chips 4a1 in the a-axis direction. Note that the number of head chips 4a1 included in the head 4a is not limited to the example illustrated in FIG. 4 and may be one or more and three or less, or may be five or more. In addition, the arrangement of the plurality of head chips 4a1 is not limited to the example illustrated in FIG. 4 and may be any arrangement.

Each head chip 4a1 has a plurality of nozzles N. The plurality of nozzles N are arranged in a nozzle row NL1 and a nozzle row NL2 spaced apart in the a-axis direction. Each of the nozzle row NL1 and the nozzle row NL2 is a set of nozzles N aligned in a straight line in the arrangement direction DN which is the b-axis direction. Here, the arrangement direction DN of the plurality of nozzles N of the head 4a is a direction intersecting the distal-end rotation axis O4. Note that the elements related to the nozzles N of either of the nozzle row NL1 or the nozzle row NL2 may be omitted. From the viewpoint of print image quality, the density of the plurality of nozzles N arranged in a straight line should be preferably 50 nozzles or more per inch and more preferably 300 nozzles or more per inch. Conversely, when the nozzle density is low, there are cases that do not require the configuration of the present disclosure because minute vibrations of the head unit 4 need not be considered.

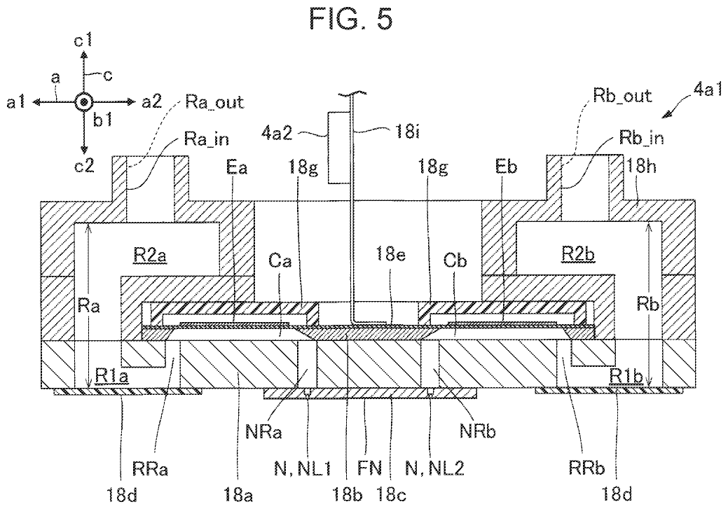

FIG. 5 is a cross-sectional view of a head chip 4a1 illustrating a configuration example. As illustrated in FIG. 5, the head chip 4a1 includes a flow-path substrate 18a, a pressure-chamber substrate 18b, the nozzle plate 18c, a vibration absorber 18d, a vibration plate 18e, the plurality of drive elements Ea and Eb, a cover 18g, a case 18h, a wiring substrate 18i, and a drive circuit 18j.

The flow-path substrate 18a and the pressure-chamber substrate 18b are stacked in this order in the c1 direction and form flow paths for supplying ink to the plurality of nozzles N. In the following, the elements of the head chip 4a1 will be described in order.

The nozzle plate 18c is a plate-shaped member having the plurality of nozzles N for the nozzle row NL1 and the nozzle row NL2.

The flow-path substrate 18a has, for the nozzle row NL1 and the nozzle row NL2, spaces R1a and R1b, a plurality of supply flow paths RRa and RRb, and a plurality of communication flow paths NRa and NRb, respectively. Each of the spaces R1a and R1b is an elongated opening extending in the Y-axis direction in plan view in the Z-axis direction. Each of the supply flow paths RRa and RRb and each of the communication flow paths NRa and NRb are through holes formed for the corresponding nozzle N. Each supply flow path RRa communicates with the space R1a. Each supply flow path RRb communicates with the space R1b.

The pressure-chamber substrate 18b is a plate-shaped member having a plurality of pressure chambers Ca and a plurality of pressure chambers Cb. The plurality of pressure chambers Ca are aligned in the b-axis direction. Similarly, the plurality of pressure chambers Cb are aligned in the b-axis direction. Each pressure chamber Ca is formed for the corresponding nozzle N in the nozzle row NL1 and is an elongated space extending in the a-axis direction in plan view. Similarly, each pressure chamber Cb is formed for the corresponding nozzle N in the nozzle row NL2 and is an elongated space extending in the a-axis direction in plan view. As with the nozzle plate 18c described above, each of the flow-path substrate 18a and the pressure-chamber substrate 18b is fabricated, for example, by processing a silicon single crystal substrate by using semiconductor manufacturing techniques.

The pressure chamber Ca communicates with both the communication flow path NRa and the supply flow path RRa. Thus, the pressure chamber Ca communicates with the nozzle N in the nozzle row NL1 via the communication flow path NRa and also communicates with the space R1a via the supply flow path RRa. Similarly, the pressure chamber Cb communicates with both the communication flow path NRb and the supply flow path RRb. Thus, the pressure chamber Cb communicates with the nozzle N in the nozzle row NL2 via the communication flow path NRb and also communicates with the space R1b via the supply flow path RRb.

The vibration plate 18e is located on the surface of the pressure-chamber substrate 18b facing the c1 direction. The vibration plate 18e is a plate-shaped member configured to vibrate elastically.

The plurality of drive elements Ea and the plurality of drive elements Eb are located on the surface of the vibration plate 18e facing the c1 direction. The drive elements Ea and Eb are passive elements that deform when receiving drive signals. Each of the drive elements Ea and Eb has an elongated shape extending in the a-axis direction in plan view. The plurality of drive elements Ea are aligned in the b-axis direction so as to be associated with the respective pressure chambers Ca. Similarly, the plurality of drive elements Eb are aligned in the b-axis direction so as to be associated with the respective pressure chambers Cb.

Each of the drive elements Ea and Eb has a first electrode, a piezoelectric layer, and a second electrode (not illustrated) that are stacked in this order in the c1 direction. One of the first electrode and the second electrode is an individual electrode provided for each drive element Ea and each drive element Eb such that these individual electrodes are spaced apart from one another, and the drive signal is applied to the one of the electrodes. The other of the first electrode and the second electrode is a strip-shaped common electrode extending in the b-axis direction so as to be continuous across the plurality of drive elements Ea and the plurality of drive elements Eb, and a specified reference potential is supplied to the other of the electrodes. The piezoelectric layer is made of a piezoelectric material such as lead zirconate titanate (Pb(Zr,Ti)O₃). When the drive element Ea thus formed deforms, the vibration plate 18e vibrates, and the pressure in the pressure chamber Ca changes. With this operation, ink is selectively ejected from specified nozzles N in the nozzle row NL1. Note that the drive elements may be heat generating elements that heat ink in the pressure chambers Ca and Cb, instead of the drive elements Ea and Eb.

The cover 18g is a plate-shaped member provided on the surface of the vibration plate 18e facing the c1 direction. The cover 18g is configured to protect the plurality of drive elements Ea and the plurality of drive elements Eb and also to reinforce the mechanical strength of the vibration plate 18e. Here, the plurality of drive elements Ea and the plurality of drive elements Eb are housed between the cover 18g and the vibration plate 18e. The cover 18g is made of, for example, a resin material.

The case 18h is configured to store the ink to be supplied to the plurality of pressure chambers Ca and the plurality of pressure chambers Cb. The case 18h has spaces R2a and R2b, inlets Ra_in and Rb_in, and outlets Ra_out and Rb_out. The space R2a communicates with the space R1a described above and functions, together with the space R1a, as a liquid storing chamber Ra which is a reservoir for storing the ink to be supplied to the plurality of pressure chambers Ca.

The vibration absorber 18d is also referred to as a compliance substrate and is a flexible resin film serving as a wall surface of the liquid storing chambers Ra and Rb. The vibration absorber 18d is configured to absorb changes in the pressure of the ink in the liquid storing chambers Ra and Rb.

The wiring substrate 18i is a mounted part for electrically coupling the drive substrate 4b and the head chip 4a1 and is mounted on the surface of the vibration plate 18e facing the c1 direction. The wiring substrate 18i is, for example, a flexible wiring substrate such as a chip-on-film (COF), a flexible printed circuit (FPC), or a flexible flat cable (FFC). The switch circuit 4a2 described above is mounted on the wiring substrate 18i of the present embodiment. The switch circuit 4a2 supplies each of the drive elements Ea and Eb with the drive signal Com as the drive pulse PD in accordance with the control signal SI.

The head chip 4a1 described above is supplied with ink from an ink tank (not illustrated) via a pressure adjustment valve (not illustrated). The pressure adjustment valve is a valve mechanism that opens and closes in accordance with the pressure of the ink in the head chip 4a1. This opening/closing operation keeps the pressure of the ink in the head chip 4a1 at a negative pressure within a specified range even if the positional relationship between the head chip 4a1 and the ink tank (not illustrated) described above changes. Note that the pressure adjustment valve may be provided for each head chip 4a1 or may be configured such that ink is supplied through one pressure adjustment valve to the plurality of head chips 4a1 via branched flow paths. The pressure adjustment valve may be a component of the head 4a or may be a component of the head unit 4, separate from the head 4a.

The drive substrate 4b illustrated in FIG. 4 includes electronic parts and a wiring substrate constituting the circuit described above and illustrated in FIG. 2.

### 1-5. Print Operation

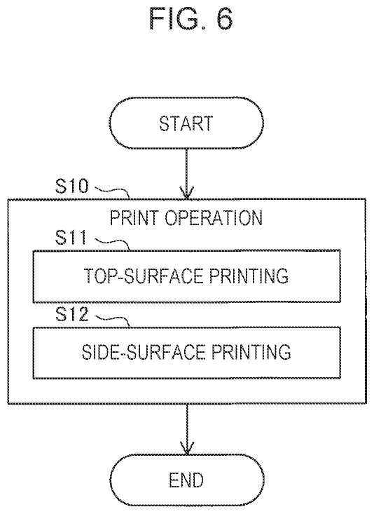

FIG. 6 is a flowchart illustrating an example of a print operation of the three-dimensional-object printing apparatus 1 according to the first embodiment. The three-dimensional-object printing apparatus 1 performs a print operation S10. In the example illustrated in FIG. 6, the print operation S10 includes top-surface printing S11 for performing printing on the top surface Wc of the workpiece W described above and side-surface printing S12 for performing printing on a side surface Ws of the workpiece W. The order of the top-surface printing S11 and the side-surface printing S12 may be determined as appropriate. In the following, the top-surface printing S11 and the side-surface printing S12 will be described in order.

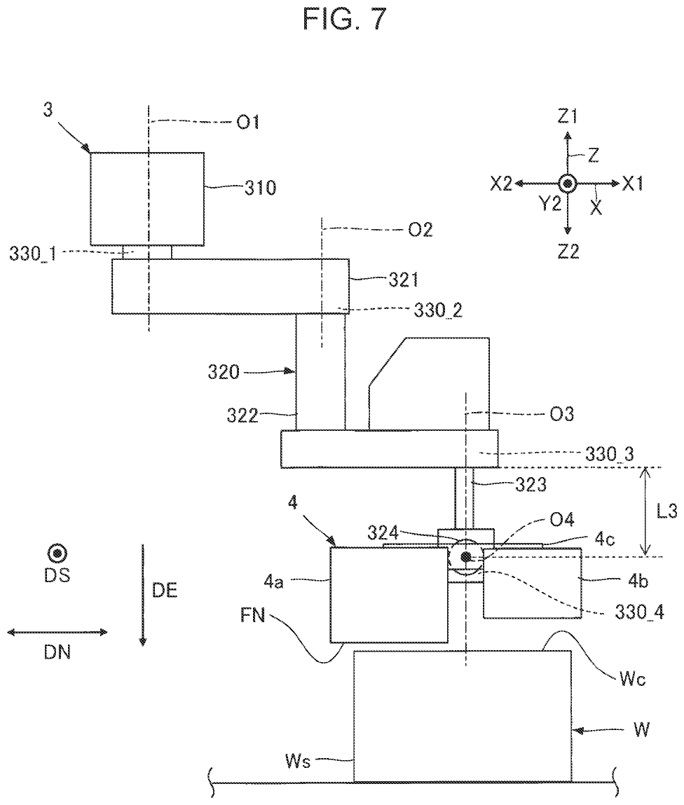

FIG. 7 is a diagram for explaining the top-surface printing S11 by the three-dimensional-object printing apparatus 1 according to the first embodiment. In the top-surface printing S11, the head 4a ejects ink toward the top surface Wc of the workpiece W while the robot 3 is changing the position of the head 4a relative to the workpiece W. In this process, the nozzle surface FN faces the top surface Wc, and the head 4a moves in a direction DS intersecting the arrangement direction DN of the plurality of nozzles N and the ejection direction DE. Here, the first joint 330_1, the second joint 330_2, and the third joint 330_3 operate such that the head 4a moves in the direction DS in a state in which the angles which the head 4a forms with the arrangement direction DN and the direction DS are constant. In this process, the distal-end joint 330_4 need not operate.

In the example illustrated in FIG. 7, the ejection direction DE corresponds to the Z2 direction, the arrangement direction DN to the X-axis direction, and the direction DS to the Y-axis direction.

Here, in the top-surface printing S11, the head 4a ejects ink toward the workpiece W while the robot 3 is changing the position of the head 4a relative to the workpiece W in a state in which the head 4a and the drive substrate 4b are aligned in a direction intersecting the third axis O3. During the top-surface printing S11, the head 4a is horizontally aligned with the drive substrate 4b. As described above, during the top-surface printing S11, the head unit 4 is oriented such that the head 4a is not located vertically above the drive substrate 4b.

Here, the length L3 of the third arm 323 is shorter than the maximum length and should preferably be, for example, less than 50% of the maximum length. In other words, the extension ratio of the third arm 323 should preferably be less than 50% in the top-surface printing S11. With this setting, it is possible to keep a margin for the third arm 323 to extend for the side-surface printing S12.

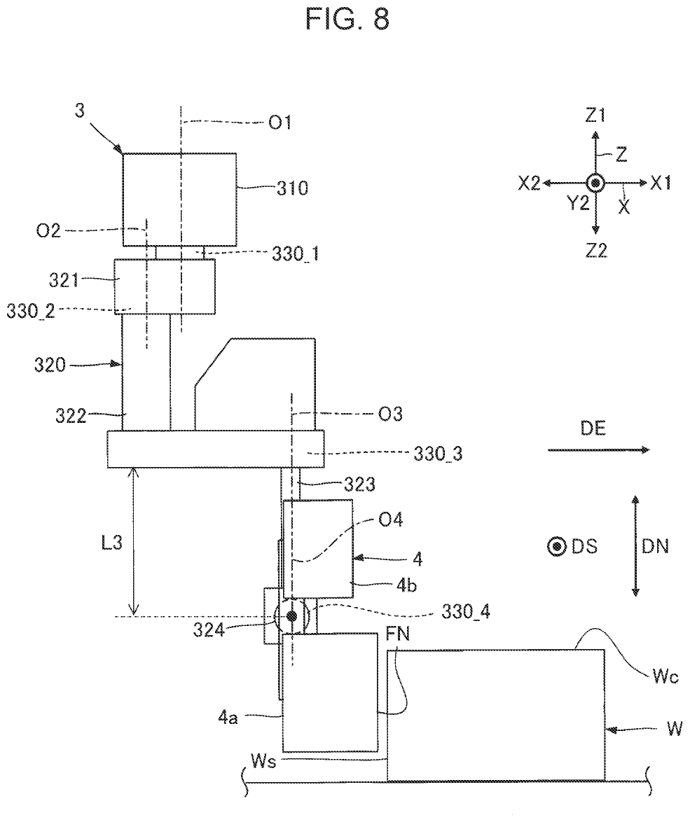

FIG. 8 is a diagram for explaining the side-surface printing S12 by the three-dimensional-object printing apparatus 1 according to the first embodiment. In the side-surface printing S12, the head 4a ejects ink toward a side surface Ws of the workpiece W while the robot 3 is changing the position of the head 4a relative to the workpiece W. In this process, the nozzle surface FN faces the side surface Ws, and the head 4a moves in the direction DS intersecting the arrangement direction DN of the plurality of nozzles N and the ejection direction DE. Here, the first joint 330_1, the second joint 330_2, and the third joint 330_3 operate such that the head 4a moves in the direction DS in a state in which the angles which the head 4a forms with the arrangement direction DN and the direction DS are constant. In this process, the distal-end joint 330_4 need not operate.

In the example illustrated in FIG. 8, the ejection direction DE corresponds to the X1 direction, the arrangement direction DN to the Z-axis direction, and the direction DS to the Y-axis direction. FIG. 8 illustrates an example in which printing is performed on the side surface Ws facing the X2 direction of the four side surfaces Ws.

Here, in the side-surface printing S12, the head 4a ejects ink toward the workpiece W while the robot 3 is changing the position of the head 4a relative to the workpiece W in a state in which the head 4a and the drive substrate 4b are aligned in the third axis O3 direction. During the side-surface printing S12, the head 4a is located vertically below the drive substrate 4b. In other words, during the side-surface printing S12, the head unit 4 is oriented such that the head 4a is not located vertically above the drive substrate 4b.

Here, the length L3 of the third arm 323 should preferably be 50% or more of the maximum length. In other words, the extension ratio of the third arm 323 in the side-surface printing S12 should preferably be 50% or more. This setting makes it possible to suitably use the extension and contraction function of the third arm 323 to perform printing on the side surface Ws.

When the top-surface printing S11 and the side-surface printing S12 as above are performed sequentially, in the period from the time when printing of one of the top-surface printing S11 and the side-surface printing S12 has finished to the time when the other printing starts, the orientation of the head unit 4 changes by 90° around the distal-end rotation axis O4. Here, in a configuration in which the distal-end rotation axis O4 is not located between the center of gravity G1 of the head 4a and the center of gravity G2 of the drive substrate 4b as viewed in the ejection direction DE, undesired vibration is likely to occur in the head unit 4 due to such an orientation change. Accordingly, the other printing needs to start at a later timing, or the image quality of the other printing can deteriorate. In contrast, in a configuration, as in the present embodiment, in which the distal-end rotation axis O4 is located between the center of gravity G1 of the head 4a and the center of gravity G2 of the drive substrate 4b as viewed in the ejection direction DE, it is possible to reduce undesired vibration in the head unit 4 caused due to such an orientation change. Thus, it is possible to start the other printing promptly without causing a deterioration in the image quality of the other printing.

In both the top-surface printing S11 and the side-surface printing S12, when an adhesive tape is attached to part of the workpiece W, it is preferable that the distance between the head 4a and the workpiece W be larger when the head 4a passes over the adhesive tape than when performing printing. With this operation, even when the adhesive tape is curled up, it is possible to prevent the head 4a from coming into contact with the adhesive surface of the adhesive tape.

The three-dimensional-object printing apparatus 1 thus configured includes the head unit 4 and the robot 3 as described above. The head unit 4 includes the head 4a that ejects ink, which is an example of a liquid, toward the workpiece W and the drive substrate 4b that generates the drive signal Com for driving the head 4a. The robot 3 includes the distal-end arm 324 that supports the head unit 4 and the distal-end joint 330_4 provided at the distal-end arm 324 and configured to rotate the head unit 4 around the distal-end rotation axis O4, and the robot 3 changes the position and orientation of the head 4a relative to the workpiece W.

In addition, the distal-end rotation axis O4 is located between the center of gravity G1 of the head 4a and the center of gravity G2 of the drive substrate 4b as viewed in the ejection direction DE in which the head 4a ejects ink. In the present embodiment, the distal-end rotation axis O4 is located between the head 4a and the drive substrate 4b as viewed in the ejection direction DE.

In the three-dimensional-object printing apparatus 1 described above, since the head unit 4, which is an end effector of the robot 3, includes the head 4a and the drive substrate 4b, the wiring 11 and 12 electrically coupling the head 4a and the drive substrate 4b need not be extended to a surrounding of the robot 3, and in addition, the wiring 11 and 12 can be short. Thus, it is possible to reduce the attenuation of the drive signal Com caused due to the wire length of the wiring 12. In addition, since the distal-end rotation axis O4 is located between the head 4a and the drive substrate 4b as viewed in the ejection direction DE, the center of gravity of the head unit 4 can be closer to the distal-end rotation axis O4. With this configuration, in the rotary motion of the head unit 4 around the distal-end rotation axis O4, the drive substrate 4b functions as the counterweight of the head 4a. Thus, the load on the distal-end joint 330_4 of the robot 3 can be small, which improves the reliability of the robot 3, reduces an unintentional rotary motion of the head unit 4 around the distal-end rotation axis O4 and the vibration of the head unit 4 during a print operation, leading to an improvement in print quality.

Although the distal-end rotation axis O4 is located between the head 4a and the drive substrate 4b as viewed in the ejection direction DE in the present embodiment, the distal-end rotation axis O4 has only to be located between the center of gravity G1 of the head 4a and the center of gravity G2 of the drive substrate 4b as viewed in the ejection direction DE. Hence, as long as the distal-end rotation axis O4 is located between the center of gravity G1 of the head 4a and the center of gravity G2 of the drive substrate 4b as viewed in the ejection direction DE, the head 4a and the drive substrate 4b may partially overlap each other as viewed in the ejection direction DE.

Although the drive substrate 4b includes all of the timing-signal generation circuit 4b1, the power supply circuit 4b2, the control circuit 4b3, and the drive-signal generation circuit 4b4 in the present embodiment, the present disclosure is not limited to this configuration. The drive substrate 4b in the present disclosure has only to have at least one of the timing-signal generation circuit 4b1, the power supply circuit 4b2, the control circuit 4b3, and the drive-signal generation circuit 4b4, as another example. In particular, the power supply circuit 4b2 and the like may be included in another substrate provided outside the head unit 4. However, from the viewpoint of reducing the attenuation of the drive signal Com caused due to the wire length of the wiring 12, it is preferable that the drive substrate 4b provided in the head unit 4 have at least the drive-signal generation circuit 4b4. In addition, from the viewpoint of reducing a delay in signals, it is more preferable that the drive substrate 4b provided in the head unit 4 include, in addition to the drive-signal generation circuit 4b4, at least one or both of the timing-signal generation circuit 4b1 and the control circuit 4b3.

As described above, the distal-end rotation axis O4 is located between the head 4a and the drive substrate 4b as viewed in the direction parallel to the distal-end rotation axis O4 in the present embodiment. Thus, the center of gravity of the head unit 4 can be suitably closer to the distal-end rotation axis O4.

In addition, as described above, the head 4a includes the plurality of nozzles N that ejects ink, the plurality of pressure chambers Ca and Cb associated with the plurality of nozzles N and communicating with the nozzles N, and the plurality of drive elements Ea and Eb associated with the plurality of pressure chambers Ca and Cb and configured to change the pressure in the pressure chambers Ca and Cb. The drive signal Com is a pulse signal supplied to the plurality of drive elements Ea and Eb. Since a pulse signal is susceptible to a long length of the transmission path, the waveform can deteriorate, and noise mixed in can affect the signal. Hence, the pulse signal used for the drive signal Com is generated in the head unit 4. Since the transmission path for the pulse signal is shorter in this configuration than in a configuration in which the pulse signal is generated outside the head unit 4, it is possible to reduce a deterioration in the waveform of the pulse signal and noise mixed in.

In addition, as described earlier, the arrangement direction DN of the plurality of nozzles N of the head 4a intersects the distal-end rotation axis O4. In the configuration in which the arrangement direction DN of the plurality of nozzles N intersects the distal-end rotation axis O4, the distance L1 is larger than in the configuration in which the arrangement direction DN is parallel to the distal-end rotation axis O4. Accordingly, the moment of inertia when the head 4a is rotated around the distal-end rotation axis O4 is large. Hence, in the configuration in which the arrangement direction DN of the plurality of nozzles N intersects the distal-end rotation axis O4, the effect of using the drive substrate 4b as the counterweight is significant.

As described earlier, the robot 3 includes the base portion 310, the first arm 321, the second arm 322, the third arm 323, and the distal-end arm 324. Here, the base portion 310 and the first arm 321 are coupled to each other via the first joint 330_1 configured to rotate around the first axis O1. The first arm 321 and the second arm 322 are coupled to each other via the second joint 330_2 configured to rotate around the second axis O2 parallel to the first axis O1. The second arm 322 and the third arm 323 are coupled to each other via the third joint 330_3 configured to rotate around the third axis O3 parallel to the second axis O2. The third arm 323 and the distal-end arm 324 are coupled to each other via the distal-end joint 330_4 configured to rotate around the distal-end rotation axis O4. The third joint 330_3 is configured to extend and contract in the third axis O3 direction. The first axis O1 and the distal-end rotation axis O4 intersect each other. The robot 3 configured as above can be built by using a SCARA robot.

As described earlier, the three-dimensional-object printing apparatus 1 performs the print operation S10. In the print operation S10, the head 4a ejects ink toward the workpiece W while the robot 3 is changing the position of the head 4a relative to the workpiece W in a state in which the head 4a and the drive substrate 4b are aligned in the third axis O3 direction. Hence, the print operation S10 can be performed with the head 4a at a position in a state in which the third arm 323 is extended. This enables a wide printing range.

Here, as described earlier, when the extension ratio of the third joint 330_3 is 50% or more during the print operation S10 (specifically, during the side-surface printing S12), the printing range can be large.

In addition, as described earlier, during the print operation S10 (specifically, during the top-surface printing S11 and the side-surface printing S12), the head unit 4 is oriented such that the head 4a is not located vertically above the drive substrate 4b. Thus, even if ink is leaked out of the head 4a, the leaked ink cannot reach the drive substrate 4b.

### 2. Second Embodiment

A second embodiment of the present disclosure will be described below. In the following embodiment illustrated as an example, the elements having the actions and functions the same as or similar to those in the first embodiment are denoted by the same reference numerals used in the description of the first embodiment, and detailed description thereof is omitted as appropriate.

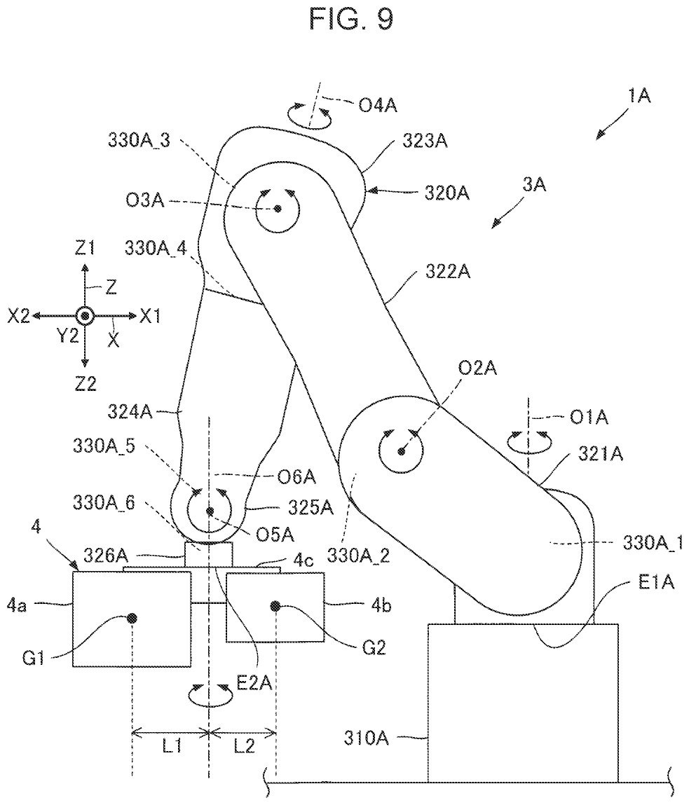

FIG. 9 is a schematic diagram of a three-dimensional-object printing apparatus 1A according to the second embodiment. The three-dimensional-object printing apparatus 1A has a configuration the same as or similar to that of the three-dimensional-object printing apparatus 1 in the first embodiment described above except that the three-dimensional-object printing apparatus 1A includes a robot 3A instead of the robot 3.

The robot 3A is a so-called 6-axis vertical articulated robot. As illustrated in FIG. 9, the robot 3A includes a base portion 310A and an arm portion 320A.

The base portion 310A is a stand that supports the arm portion 320A. In the example illustrated in FIG. 9, the base portion 310A is fixed by screwing or the like to an installation surface facing the Z1 direction such as a floor surface or a base table

The arm portion 320A is a 6-axis robot arm including a proximal end E1A attached to the base portion 310A and a distal end E2A whose three-dimensional position and orientation change relative to the proximal end E1A. Specifically, the arm portion 320A includes arms 321A, 322A, 323A, 324A, and 325A and a distal-end arm 326A, which are also referred to as links, and these arms are coupled to one another in this order.

The arm 321A is coupled to the base portion 310A via a joint 330A_1 so as to be configured to rotate around a first axis O1A relative to the base portion 310A. The arm 322A is coupled to the arm 321A via a joint 330A_2 so as to be configured to rotate around a second axis O2A relative to the arm 321A. The arm 323A is coupled to the arm 322A via a joint 330A_3 so as to be configured to rotate around a third axis O3A relative to the arm 322A. The arm 324A is coupled to the arm 323A via a joint 330A_4 so as to be configured to rotate around a fourth axis O4A relative to the arm 323A. The arm 325A is coupled to the arm 324A via a joint 330A_5 so as to be configured to rotate around a fifth axis O5A relative to the arm 324A. The distal-end arm 326A is coupled to the arm 325A via a distal-end joint 330A_6 so as to be configured to rotate around a distal-end rotation axis O6A relative to the arm 325A.

Each of the joints 330A_1 to 330A_5 and the distal-end joint 330A_6 is a mechanism that couples one of the two members adjoining each other, of the base portion 310A, the arms 321A to 325A, and the distal-end arm 326A, to the other such that the one member is configured to rotate relative to the other. In the following description, each of the joints 330A_1 to 330A_5 and the distal-end joint 330A_6 may sometimes be referred to as “joint 330A”.

The joint 330A has a driving mechanism (not illustrated in FIG. 9) that rotates one of the corresponding two members adjoining each other relative to the other. The driving mechanism includes, for example, a motor that generates a driving force for the rotation, a speed reducer that reduces the speed resulting from the driving force and outputs the resultant, and an encoder, such as a rotary encoder, that detects the amount of operation such as the rotation angle.

The first axis O1A is perpendicular to the installation surface (not illustrated) to which the base portion 310A is fixed. The second axis O2A is perpendicular to the first axis O1A. The third axis O3A is parallel to the second axis O2A. The fourth axis O4A is perpendicular to the third axis O3A. The fifth axis O5A is perpendicular to the fourth axis O4A. The distal-end rotation axis O6A is perpendicular to the fifth axis O5A.

A head unit 4 is attached as an end effector to the distal-end arm 326A of the robot 3A described above by being fixed by screwing or the like. Here, the head unit 4 is configured such that the moment of the head unit 4 around the distal-end rotation axis O6A is smaller.

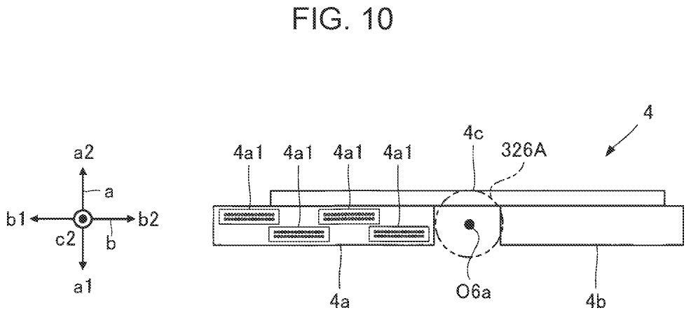

FIG. 10 is a diagram for explaining the positional relationship between the head unit 4 used in the second embodiment and the distal-end rotation axis O6A. As illustrated in FIG. 10, the distal-end rotation axis O6A is located between the head 4a and the drive substrate 4b as viewed in the ejection direction in which the head 4a ejects ink. Here, for example, a support 4c is fixed to the distal-end arm 326A by screwing or the like.

In the three-dimensional-object printing apparatus 1A configured as above, for example, when the head unit 4 scans in the Y1 direction or the Y2 direction in printing, driving of the distal-end joint 330A_6 is controlled so as to keep the orientation of the head unit 4, so that the head unit 4 rotates around the distal-end rotation axis O6A. As another example, the head unit 4 can scan parallel to the X-axis and the Y-axis in the orientation of the robot 3A illustrated in FIG. 9. For example, when the head unit 4 scans in the X2 direction in printing, the distal-end joint 330A_6 need not be driven. However, the configuration in which the distal-end rotation axis O6A is located between the head 4a and the drive substrate 4b as viewed in the ejection direction is useful as described earlier from the viewpoint of reducing undesired vibration of the head unit 4 resulting from vibration of other driven joints.

The second embodiment described above also improves the reliability of the robot 3A and reduces vibration of the head unit 4 during a print operation, leading to an improvement in print quality. In the present embodiment, as described earlier, the distal-end joint 330A_6 is driven during the print operation in which the head 4a ejects ink toward the workpiece W while the robot 3A is changing the position of the head 4a relative to the workpiece W. In the configuration in which the distal-end joint 330A_6 is driven during the print operation, the effect of using the drive substrate 4b as the counterweight is more significant than in the configuration in which the distal-end joint 330A_6 is not driven.

### 5. Modification Example

Each configuration described above as an example may be modified in various ways. The following describes configurations with specific modifications applicable to the embodiments described above, as examples. Any two or more configurations selected from the following examples may be combined as appropriate within a range in which these configurations do not make a contradiction.

### 5-1. Modification Example 1

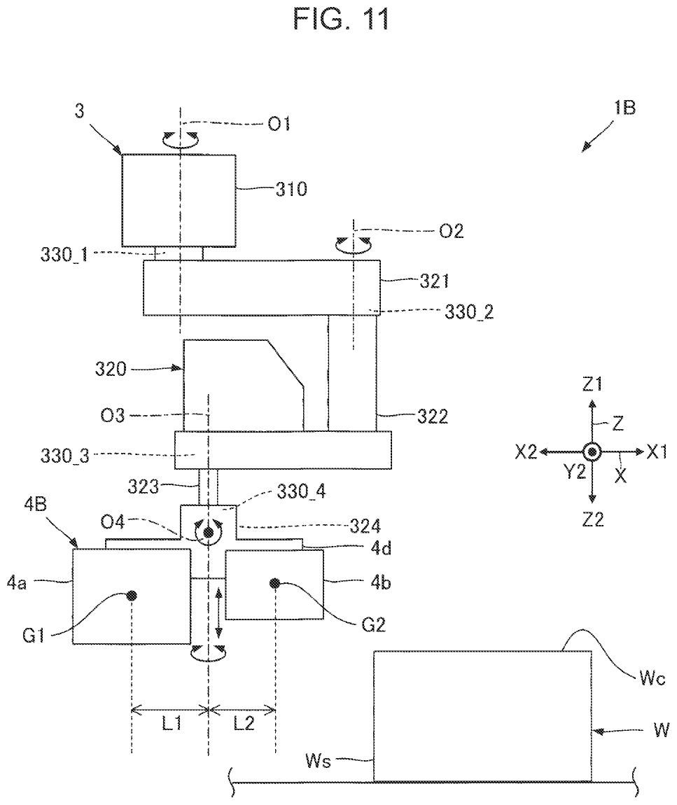

FIG. 11 is a schematic diagram of a three-dimensional-object printing apparatus 1B according to a modification example. The three-dimensional-object printing apparatus 1B has a configuration the same as or similar to that of the three-dimensional-object printing apparatus 1 in the first embodiment except that the three-dimensional-object printing apparatus 1B includes a head unit 4B instead of the head unit 4. The head unit 4B has a configuration the same as or similar to that of the head unit 4 in the first embodiment except that the head unit 4B includes a support 4d instead of the support 4c. The support 4d has a configuration the same as or similar to that of the support 4c in the first embodiment except that the positional relationship between the distal-end rotation axis O4 and the centers of gravity G1 and G2 is different.

In the example illustrated in FIG. 11, the distal-end rotation axis O4 is located in the Z1 direction relative to the head 4a and the drive substrate 4b as viewed in the distal-end rotation axis O4 direction. However, the distal-end rotation axis O4 is located between the head 4a and the drive substrate 4b as viewed in the ejection direction DE. Also, the modification example 1 described above reduces the load on the distal-end joint 330_4 of the robot 3 to improve the reliability of the robot 3, and also reduces vibration of the head unit 4 during a print operation, leading to an improvement in print quality.

### 5-2. Modification Example 2

Although the embodiments described above are based on the examples in which a 4-axis or 6-axis articulated robot is used as the robot, the present disclosure is not limited to these configurations. The robot may be, for example, an articulated robot other than ones with four axes or six axes.

Here, when the end effector has a joint function, the end effector is regarded as part of the components of the robot. Of the plurality of joints of the robot, the most distal rotary joint corresponds to the distal-end joint, and the axis around which the distal-end joint rotates corresponds to the distal-end rotation axis.

What is claimed is:

1. A three-dimensional-object printing apparatus comprising:
a head unit including a head configured to eject liquid toward a workpiece and a drive substrate configured to generate a drive signal for driving the head; and
a robot including a distal-end arm supporting the head unit and a distal-end joint located at the distal-end arm and enabling the head unit to rotate around a distal-end rotation axis, the robot being configured to change a position and an orientation of the head relative to the workpiece, wherein
the distal-end rotation axis is located between the head and the drive substrate as viewed in an ejection direction in which the head ejects liquid.

2. The three-dimensional-object printing apparatus according to claim 1, wherein
the distal-end rotation axis is located between the head and the drive substrate as viewed in a direction parallel to the distal-end rotation axis.

3. The three-dimensional-object printing apparatus according to claim 1, wherein
the distal-end rotation axis is located between the head and the drive substrate in the ejection direction as viewed in a direction parallel to the distal-end rotation axis.

4. The three-dimensional-object printing apparatus according to claim 3, wherein
the ejection direction is parallel to a vertical axis when the distal-end rotation axis is located between the head and the drive substrate in the ejection direction as viewed in the direction parallel to the distal-end rotation axis.

5. The three-dimensional-object printing apparatus according to claim 1, wherein
the head includes
a plurality of nozzles configured to eject liquid,
a plurality of pressure chambers associated with the plurality of nozzles and communicating with the nozzles, and
a plurality of drive elements associated with the plurality of pressure chambers and configured to change pressure in the pressure chambers, and
the drive signal is a pulse signal supplied to the plurality of drive elements.

6. The three-dimensional-object printing apparatus according to claim 1, wherein
the head includes a plurality of nozzles configured to eject liquid, and
a direction in which the plurality of nozzles is arranged intersects the distal-end rotation axis.

7. The three-dimensional-object printing apparatus according to claim 6, wherein
during a print operation in which the head ejects liquid toward the workpiece while the robot is changing the position of the head relative to the workpiece, the distal-end joint rotates around the distal-end rotation axis.

8. The three-dimensional-object printing apparatus according to claim 1, wherein
the robot further includes a base portion, a first arm, a second arm, and a third arm,
the base portion and the first arm are coupled to each other via a first joint configured to rotate around a first axis,
the first arm and the second arm are coupled to each other via a second joint configured to rotate around a second axis parallel to the first axis,
the second arm and the third arm are coupled to each other via a third joint configured to rotate around a third axis parallel to the second axis,
the third arm and the distal-end arm are coupled to each other via the distal-end joint configured to rotate around the distal-end rotation axis,
the third joint is configured to extend and contract in a direction parallel to the third axis, and
the first axis and the distal-end rotation axis intersect each other.

9. The three-dimensional-object printing apparatus according to claim 8, wherein
the three-dimensional-object printing apparatus performs a print operation in which the head ejects liquid toward the workpiece while the robot is changing the position of the head relative to the workpiece, in a state in which the head and the drive substrate are aligned in a direction parallel to the third axis.

10. The three-dimensional-object printing apparatus according to claim 9, wherein
an extension ratio of the third joint is 50% or more during the print operation.

11. The three-dimensional-object printing apparatus according to claim 8, wherein
during a print operation in which the head ejects liquid toward the workpiece while the robot is changing the position of the head relative to the workpiece, the head is not located vertically above the drive substrate.

12. The three-dimensional-object printing apparatus according to claim 1, wherein
a distance between the distal-end rotation axis and a center of gravity of the head is larger than a distance between the distal-end rotation axis and a center of gravity of the drive substrate as viewed in a direction parallel to the distal-end rotation axis, when mass of the head is shorter than mass of the substrate.

13. The three-dimensional-object printing apparatus according to claim 1, wherein
a distance between the distal-end rotation axis and a center of gravity of the head is shorter than a distance between the distal-end rotation axis and a center of gravity of the drive substrate as viewed in a direction parallel to the distal-end rotation axis, when mass of the head is larger than mass of the substrate.

14. A three-dimensional-object printing apparatus comprising:
a head unit including a head configured to eject liquid toward a workpiece and a drive substrate configured to generate a drive signal for driving the head; and
a robot including a distal-end arm supporting the head unit and a distal-end joint located at the distal-end arm and enabling the head unit to rotate around a distal-end rotation axis, the robot being configured to change a position and an orientation of the head relative to the workpiece, wherein
the distal-end rotation axis is located between a center of gravity of the head and a center of gravity of the drive substrate as viewed in an ejection direction in which the head ejects liquid.
